(19) United States
(12) Patent Application Publication
(10) Pub. No.: US 2011/0121538 A1
(43) Pub. Date: May 26, 2011

(54) FORK ASSEMBLY FOR A BICYCLE

(76) Inventor: Michel Giroux, Quebec (CA)

(21) Appl. No.: 12/995,987

(22) PCT Filed: Jun. 4, 2009
(86) PCT No.: PCT/CA2009/000784

§ 371 Date: Jan. 24, 2011

Related U.S. Application Data
(60) Provisional application No. 61/059,413, filed on Jun. 6, 2008.

(51) Int. Cl. B62K 21/02

(52) U.S. Cl. 280/280

(57) ABSTRACT

A fork assembly for a bicycle comprising a pair of spaced-apart blade operatively connected to one another by at least one of a crown plate and a stem plate. The fork assembly comprises a steer assembly for connecting the fork assembly to a head tube of a frame of a bicycle. The head tube of the bicycle comprises openings for allowing routing control cables from a handlebar through the frame of the bicycle. A method for routing the control cables from a handlebar through the frame of the bicycle is also provided.

### CROSS REFERENCE TO RELATED APPLICATIONS

This application claims priority of U.S. Provisional Patent Application Ser. No. 61/059,413 filed on Jun. 6, 2008 and entitled FORK ASSEMBLY FOR A BICYCLE, the specification of which is hereby incorporated by reference.

This application is related to U.S. Provisional Patent Application Ser. No. 61/059,387 filed on Jun. 6, 2008 and entitled BICYCLE FRAME AND CASING FOR INTERNALLY ROUTED CABLES, the specification of which is hereby incorporated by reference.

This application is related to U.S. Provisional Patent Application Ser. No. 61/059,404 filed on Jun. 6, 2008 and entitled HANDLEBAR FOR A BICYCLE, the specification of which is hereby incorporated by reference.

This application is related to U.S. Provisional Patent Application Ser. No. 61/059,421 filed on Jun. 6, 2008 and entitled SADDLE ANTI-THEFT DEVICE, the specification of which is hereby incorporated by reference.

### FIELD OF THE INVENTION

The present invention generally relates to a fork assembly for a bicycle. More specifically, the present invention relates to a fork assembly comprising a pair of spaced-apart blade members operatively connected to one another by a crown plate and a stem plate. The invention also relates to a method for routing control cables from a handlebar through the frame of the bicycle.

### BACKGROUND OF THE INVENTION

Bicycles have been utilized as means of transportation for over a hundred years. Modern bicycles generally include control cables which are used to control front and rear wheel braking systems, and front and rear shifting mechanisms. Typically, the cables are routed from brake and shift levers to the braking systems and derailleur. The bicycle may also have wires for an odometer and front and rear lights. Those cables and wires are generally mounted along the outside of the bicycle frame with various attachments such as clips.

Cables and wires can interfere with either the rider or other components of the bicycles (e.g. tool compartment attached to the frame). Externally located cables and wires are susceptible to damage from the surrounding environment (e.g. tree, branches) and also from vandalism. The cables may also detract from the aesthetic appearance of the frame by covering art or graphic logos.

For different reasons, many cities have inaugurated in the recent years bicycle sharing programs whereby citizens can easily have access to bicycles for inner-city transportation. Although very popular, those programs have to struggle against theft and vandalism. There is therefore a need for new bikes with a frame design preventing vandalism or disassembly of the parts of the bike.

Prior attempts have been made to conceal bicycle cables and wires by extending the cables through the inside of the bicycle frame components. Examples are disclosed in U.S. Pat. No. 7,114,738 and US Patent Publications Nos. 2004/0188976 and 2006/0145446. However, those frames do not address many of the above-identified problems, either because they maintain some exposed segments of cables, because they are too complex, because the configuration of the frame is such that cables wear prematurely due to continuous scrubbing against the frame, or because they are not adaptable to bikes designed to be used in bicycle sharing programs.

Therefore, it would be desirable to be provided with an assembly for a bicycle, where the assembly would contribute to reduce at least one of the above-mentioned drawbacks.

### BRIEF SUMMARY

Accordingly, there is provided a fork assembly for a bicycle having a frame. The fork assembly comprises a first blade and a second spaced-apart blade, each of the first blade and the second blade comprising a lower wheel portion and an upper steer portion defining a junction therebetween. The fork assembly comprises a crown plate mounted to the steer portion of the first blade and the steer portion of the second blade, and a stem plate mounted to the steer portion of the first blade and to the steer portion of the second blade above the crown plate. The stem plate and the crown plate are adapted for holding the blades in a position for receiving a wheel of the bicycle between the wheel portion of the first blade and the wheel portion of the second blade and for defining a space between the steer portion of the first blade and the steer portion of the second blade. The fork assembly comprises a steer assembly for operatively connecting at least one of the crown plate and the stem plate to the frame of the bicycle.

The fork assembly may help increasing the robustness of the bicycle against vandalism, which is of great advantage.

In one embodiment, the upper steer portion of the first blade and the upper steer portion of the second blade are straight and parallel to each other, the lower wheel portion of the first blade and the lower wheel portion of the second blade bending outwardly proximal the corresponding junction for providing a wheel space adapted to receive the wheel of the bicycle therebetween.

In one embodiment, at least one of the crown plate and the stem plate is secured to the first blade and the second blade using a welding technique.

In one embodiment, the steer assembly comprises pivoting means for pivotally connecting at least one of the crown plate and the stem plate to the frame of the bicycle.

In one embodiment, each of the first and second blades comprises a lower end, an opposed top end and a dropout mounted at the lower end for mounting the wheel of the bicycle thereto.

In a further embodiment, the stem plate is mounted at the top end of the first blade and at the top end of the second blade.

In one embodiment, the stem plate comprises a top face for mounting a handlebar of the bicycle thereto and an opposed bottom face.

In a further embodiment, the stem plate comprises a handlebar recess defined on the top face thereof for receiving therein the handlebar.

In still a further embodiment, the stem plate comprises a first recess and a second recess extending on the bottom face thereof, each of the first recess and the second recess being adapted for receiving therein a corresponding top end of a corresponding blade.

In another embodiment, the stem plate further comprises a hole extending from the top face to the bottom face, the hole being adapted for providing a passageway for at least one control cable therethrough.

In another embodiment, the fork assembly further comprises a stem cover adapted for mounting with the stem plate to secure the handlebar received in the handlebar recess of the stem plate between the stem cover and the stem plate.

In a further embodiment, the handlebar comprises at least one control cable selected from a group consisting of a brake cable and a gear-shifter cable, the at least one control cable extending inside the handlebar and further extending through the hole of the stem plate towards the space defined between the steer portion of the first blade and the steer portion of the second blade when the handlebar is mounted to the stem plate.

In one embodiment, the crown plate is mounted at the junctions of the lower wheel portion and the upper steer portion of the first blade and the second blade.

In one embodiment, the frame of the bicycle comprises a head tube for mounting the fork assembly thereto.

In a further embodiment, the frame comprises a hollow passageway therein. The head tube comprises a first front opening and a second back opening adjacent to the passageway of the frame, the first front opening and the second back opening being adapted for providing a communication channel between the space defined between the steer portions of the first and second blades and the passageway of the frame.

This arrangement may help concealing the control cables of the bicycle inside the frame thereof, which is of great advantage for protecting the cables from vandalism and from damages from the surrounding environment.

In still a further embodiment, the head tube comprises at least one of a top open end and an opposed bottom open end. The steer assembly comprises at least one of a corresponding upper steer set and a corresponding lower steer set, the corresponding steer set comprising a bearing mounted in the head tube at a corresponding end thereof, a knob lying against and extending through a corresponding one of the crown plate and the stem plate and through the corresponding bearing, and a fastener for securing the knob to the head tube.

In one embodiment, the crown plate comprises a front end adapted for mounting a bicycle locking assembly to secure the bicycle to a fixed structure.

In one embodiment, the crown plate comprises a pair of holes extending therethrough, each of the holes being configured for receiving a respective one of the first blade and the second blade therethrough.

In one embodiment, at least one of the first blade and the second blade comprises a hollow passageway therealong, a first upper cable hole located in the steer portion and a second lower cable hole located in the wheel receiving portion for concealing a control cable in the hollow passageway of the corresponding blade.

This arrangement may further help protecting the control cables from vandalism and from damages from the surrounding environment, which is of great advantage.

In another embodiment, the fork assembly further comprises a space cover mounted against the steer portion of the first blade and the steer portion of the second blade between the bottom face of the stem plate and the top face of the crown plate for closing the space between the steer portion of the first blade and the steer portion of the second blade.

This arrangement may further contribute to the protection of the control cables, which is of great advantage.

In a further embodiment, the space cover is U-shaped and comprises a first leg and an opposed second leg, each of the first leg and the second leg overlapping a corresponding steer portion.

In another further embodiment, the space cover comprises at least one mounting bracket for mounting a rack thereto.

According to another aspect, there is also provided a bicycle comprising a frame and a fork assembly. The fork assembly comprises a first blade and a second spaced-apart blade, each of the first blade and the second blade comprising a lower wheel portion and an upper steer portion defining a junction therebetween. The fork assembly comprises a crown plate mounted to the steer portion of the first blade and the steer portion of the second blade. The fork assembly comprises a stem plate mounted to the steer portion of the first blade and to the steer portion of the second blade above the crown plate. The stem plate and the crown plate are adapted for holding the blades in a position for receiving a wheel of the bicycle between the wheel portion of the first blade and the wheel portion of the second blade and for defining a space between the steer portion of the first blade and the steer portion of the second blade. The fork assembly comprises a steer assembly for operatively connecting at least one of the crown plate and the stem plate to the frame of the bicycle. The bicycle also comprises a handlebar mounted to the stem plate.

According to another aspect, there is also provided a fork assembly kit for a bicycle having a frame. The fork assembly kit comprises a first blade and a second blade, each of the first blade and the second blade comprising a lower wheel portion and an upper steer portion defining a junction therebetween. The fork assembly kit comprises a crown plate mountable to the steer portion of the first blade and the steer portion of the second blade and a stem plate mountable to the steer portion of the first blade and to the steer portion of the second blade above the crown plate. The stem plate and the crown plate are adapted for holding the blades in a position for receiving a wheel of the bicycle between the wheel portion of the first blade and the wheel portion of the second blade and for defining a space between the steer portion of the first blade and the steer portion of the second blade when the stem plate is mounted to the steer portion of the first blade and to the steer portion of the second blade. The fork assembly kit comprises a steer assembly for operatively connecting at least one of the crown plate and the stem plate to the frame of the bicycle.

According to another aspect, there is also provided a method for routing at least one control cable of a bicycle having a frame. The method comprises providing a fork assembly, the fork assembly comprising a first blade and a second spaced-apart blade, each of the first blade and the second blade comprising a lower wheel portion and an upper steer portion defining a junction therebetween. The fork assembly comprises a crown plate mounted to the steer portion of the first blade and the steer portion of the second blade. The fork assembly comprises a stem plate mounted to the steer portion of the first blade and to the steer portion of the second blade above the crown plate, the stem plate and the crown plate being adapted for holding the blades in a position for receiving a front wheel of the bicycle between the wheel portion of the first blade and the wheel portion of the second blade and for defining a space between the steer portion of the first blade and the steer portion of the second blade, the stem plate of the fork assembly comprising a hole extending through a top face and a bottom face thereof. The fork assembly comprises a steer assembly for operatively connecting at least one of the crown plate and the stem plate to the frame of the bicycle. The method further comprises mounting the fork assembly to the frame of the bicycle; providing a handlebar comprising the at least one control cable, the at least one control cable being internally routed inside the handlebar towards a lower opening defined in the handlebar; and mounting the handlebar to the stem plate of the fork assembly such that the control cable of the handlebar runs through the lower opening thereof towards the space defined between the steer portion of the first blade and the steer portion of the second blade and further towards at least one of the frame and the front wheel of the bicycle.

In one embodiment, the method further comprises providing a stem cover adapted for mounting with the stem plate to secure the handlebar between the stem cover and the stem plate; and mounting the cover plate to the stem plate for securing the handlebar therebetween.

In another embodiment, the method further comprises providing, in at least one of the first blade and the second blade, a hollow passageway, a first upper cable hole located in the steer portion and a second lower cable hole located in the wheel receiving portion for concealing one of the control cables in the hollow passageway of the corresponding blade; and running the corresponding control cable from the space defined between the steer portion of the first blade and the steer portion of the second blade towards the second lower cable hole located in the wheel receiving portion.

These and other objects, advantages and features of the present invention will become more apparent to those skilled in the art upon reading the details of the invention more fully set forth below.

### BRIEF DESCRIPTION OF THE DRAWINGS

Having thus generally described the nature of the invention, reference will now be made to the accompanying drawings, showing by way of illustration of an illustrative embodiment thereof, and in which:

FIG. 1 is a front perspective view of a bicycle comprising a fork assembly in accordance with one embodiment of the present invention.

FIG. 2 is an enlarged front left perspective view of the fork assembly of the bicycle shown in FIG. 1, with the stem cover removed for showing the space between the blades.

FIG. 3 is a back left perspective view of a blade in accordance with one embodiment of the present invention.

FIG. 4 is a front elevation view of the fork assembly shown in FIG. 2.

FIG. 5 is a back right perspective view of a crown plate in accordance with one embodiment of the present invention.

FIG. 6 is a top plan view of the crown plate shown in FIG. 5.

FIG. 7 is a bottom plan view of the crown plate shown in FIG. 5.

FIG. 8 is a front right perspective view of a stem plate in accordance with one embodiment of the present invention.

FIG. 9 is a top plan view of the stem plate shown in FIG. 8.

FIG. 10 is a bottom plan view of the stem plate shown in FIG. 8.

FIG. 11 is a front right perspective view of a stem cover in accordance with one embodiment of the present invention.

FIG. 12 is a top plan view of the stem cover shown in FIG. 11.

FIG. 13 is a bottom plan view of the stem cover shown in FIG. 11.

FIG. 14 is a back right exploded view of the fork assembly shown in FIG. 2, with a handlebar, according to one embodiment of the present invention.

FIG. 15 is a right side exploded view of the fork assembly shown in FIG. 14.

FIG. 16 is a front right perspective view of a space cover, with a rack, in accordance with one embodiment of the present invention.

FIG. 17 a front elevation view of the space cover shown in FIG. 16.

FIG. 18 is a partial top plan view of the bicycle shown in FIG. 1.

FIG. 19 is a cross-section view of the bicycle shown in FIG. 18, taken along line 19-19.

FIG. 20 is a back right perspective view of a crown plate in accordance with another embodiment of the present invention.

FIG. 21 is a front right perspective view of a stem plate in accordance with another embodiment of the present invention.

FIG. 22 is a front right perspective view of a stem cover in accordance with another embodiment of the present invention.

FIG. 23 is a bottom plan view of the stem cover shown in FIG. 22.

FIG. 24 is a right side exploded view of a fork assembly, according to another embodiment.

FIG. 25 is a cross-section view of the fork assembly shown in FIG. 24.

FIG. 26 is a front right perspective view of a space cover, with a rack, in accordance with another embodiment of the present invention.

FIG. 27 is an exploded perspective view of the space cover and the rack shown in FIG. 26.

### DETAILED DESCRIPTION

The description which follows, and the embodiments described therein are provided by way of illustration of an example, or examples of particular embodiments of principles and aspects of the present invention. These examples are provided for the purpose of explanation and not of limitation. In the description that follows, like parts are marked throughout the specification and the drawings with the same respective reference numerals.

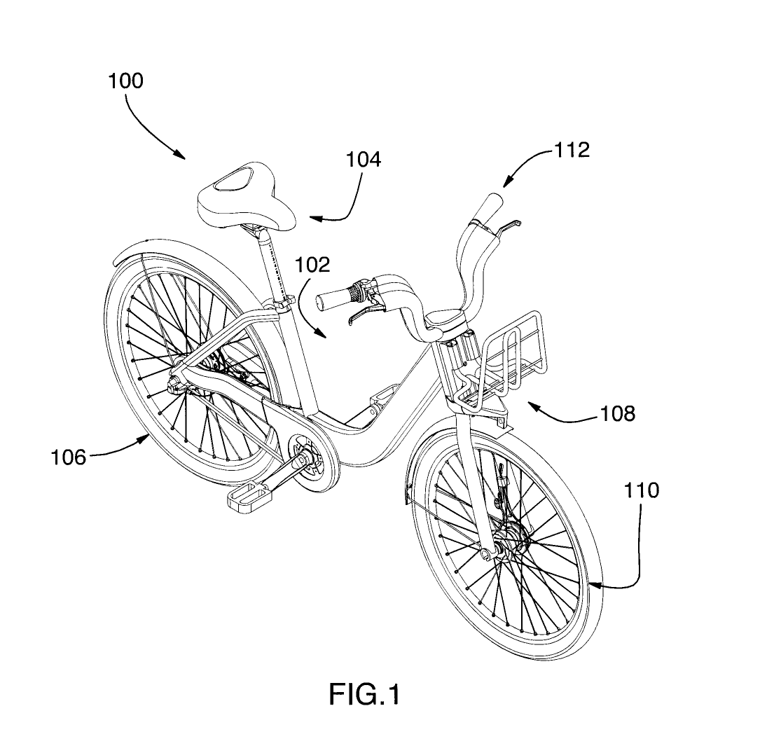

With reference to FIG. 1, a bicycle will be described in accordance with one embodiment, using the reference numeral 100. The bicycle 100 comprises a frame 102, a seat assembly 104 mounted to the frame 102 for a user to sit on the bicycle 100 and a rear wheel 106 rotatably mounted to the frame 102. The bicycle further comprises a fork assembly 108 operatively mounted to the frame 102 and a front wheel 110 rotatably mounted to the fork assembly 108. Mounted on the fork assembly 108 is a handlebar 112 for allowing the user to control the direction of the bicycle 100, as it will become apparent below.

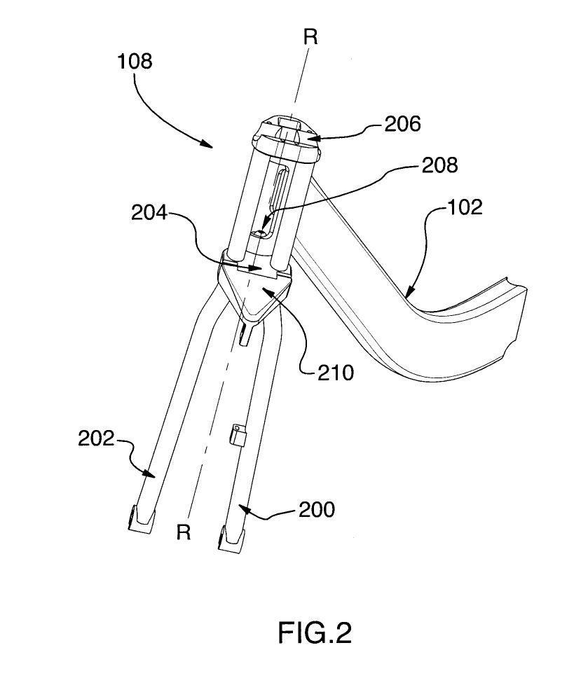

Turning to FIG. 2, the fork assembly 108 comprises a pair of spaced-apart blades 200, 202 assembled to one another in a side-by-side relation by a crown plate 204 and a spaced-apart stem plate 206. The fork assembly 108 further comprises a steer assembly 208 operatively mounted to at least one of the crown plate 204 and the stem plate 206, the two of them in the illustrated case, for operatively mounting the fork assembly 108 to the frame 102 of the bicycle 100, as best described below.

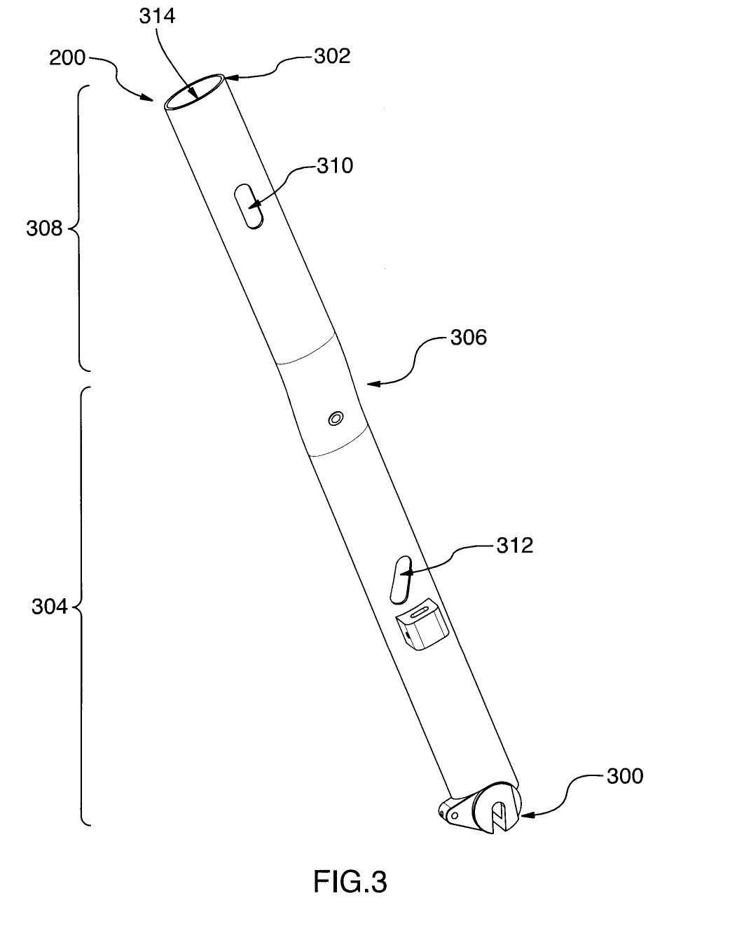

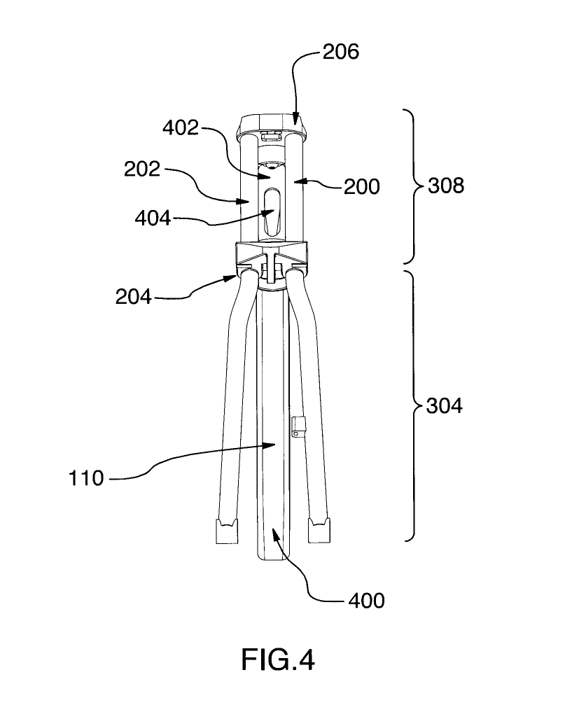

The blades 200 and 202 being mirror images of one another, only blade 200 will be described, with reference to FIGS. 3 and 4. A person skilled in the art will appreciate that a similar description also applies to blade 202, with appropriate modifications. In the illustrated embodiment, the blade 200 has an oval cross-section and comprises a lower, dropout end 300 for rotatably mounting the front wheel 110 to the fork assembly 108 and an opposed top end 302, received in the stem plate 206, as best described below. The blade 200 defines a wheel receiving portion 304 extending from the lower, dropout end 300 to an intermediate region 306 located between the dropout end 300 and the top end 302, and a steer portion 308. The steer portion 308 of the blade 200 extends from the intermediate region 306 to the upper end 302.

As best shown in FIG. 4, in one embodiment, the steer portion 308 of the blade 200 is generally straight, the steer portions 308 of the blades 200 and 202 running generally parallel to one another when the fork assembly 108 is assembled. In this embodiment, the wheel receiving portion 304 gently bents outwardly proximal to the intermediate region 306 for providing sufficient wheel space 400 between the wheel receiving portions 308 of the blades 200 and 202 to receive the front wheel 110 therebetween. In other words, the wheel receiving portions 308 of the blades 200 and 202 extend slightly away from one another to increase the distance separating the blades 200 and 202 at this location, for mounting the front wheel 110 to the dropout ends 300 of the blades 200 and 202.

The skilled addressee will appreciate that other cross-sectional shapes and overall shapes may be considered for the blades 200, 202. For example, the blades 200, 202 may have a circular or rectangular cross-section. Moreover, the overall shape of the blades may slightly differ from the one that is illustrated, as long as the blades 200, 202 are adapted for providing the wheel space 400 between the wheel receiving portions 308 of the blades to receive the front wheel 110 therebetween, and for defining a space 402 between the steer portions 308 of the blades 200, 202, as it will be more clearly detailed below.

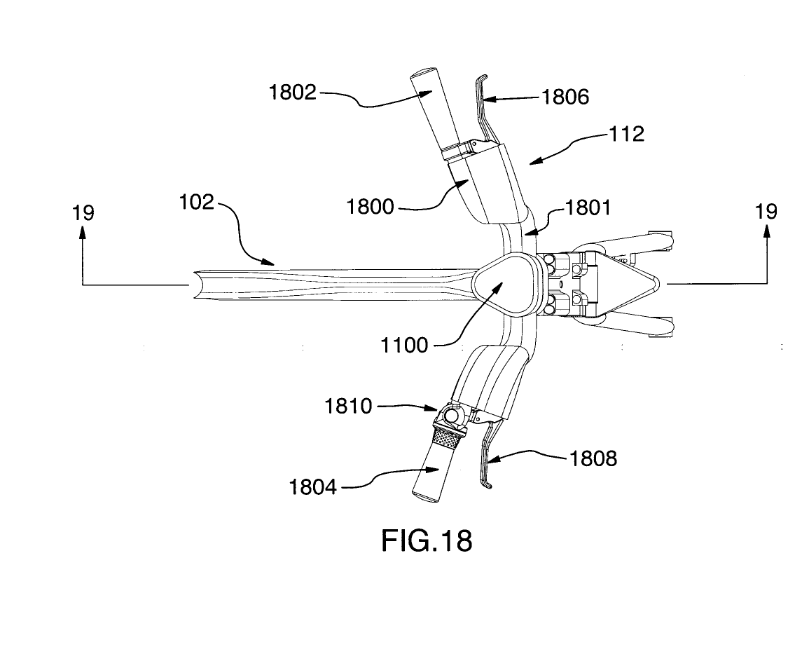

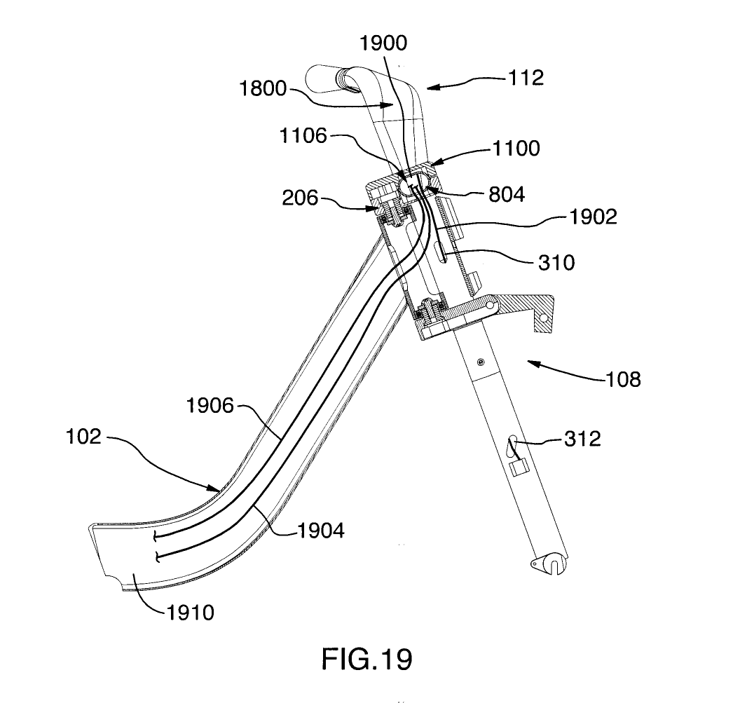

As best shown in FIG. 3, in one embodiment, the blade 200 is provided with a hollow passageway 314 therealong, a first cable hole 310 located in the steer portion 308 thereof and a second cable hole 312 defined in the wheel receiving portion 304, each of the cable holes 310, 312 being in communication with the hollow passageway 314. As it will become apparent below with reference to FIGS. 18 and 19, the first and second cable holes 310, 312 of the blade 200 enable running a front brake cable 1902 from a left brake lever assembly 1806 to the front brake (not shown), inside the handlebar 112 and the blade 200 of the fork assembly 108. In one embodiment, the first cable hole 310 and the second cable hole 312 are located on the inner side of the blade 200 facing the wheel space 400 receiving the front wheel of the bicycle. The skilled addressee will however appreciate that other arrangements may be considered.

As illustrated in FIGS. 2 and 4, the blades 200 and 202 are hold in position relative to one another by the crown plate 204 and the stem plate 206, which will now be described.

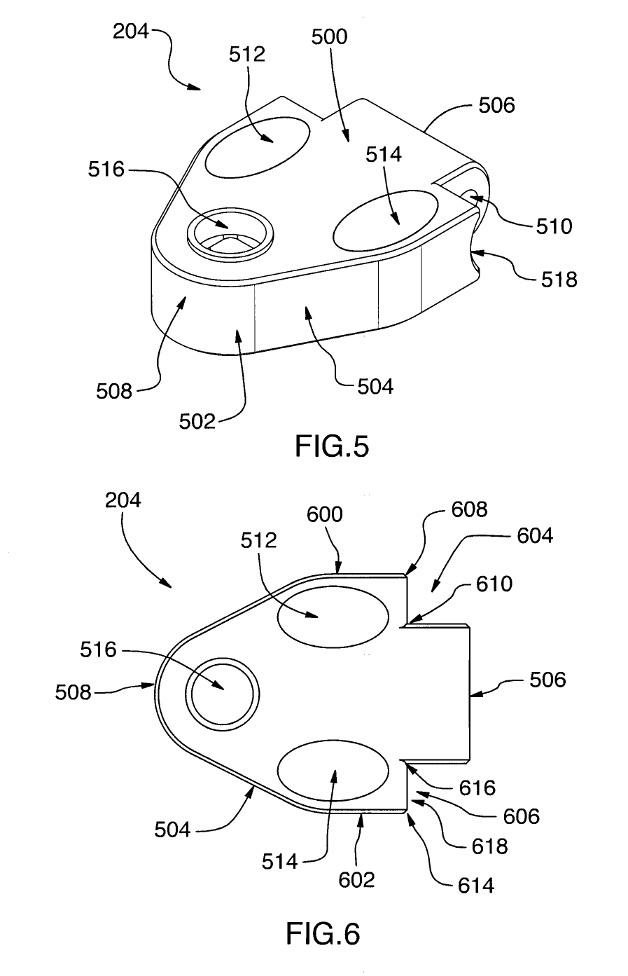

With reference to FIGS. 5 to 7, in one embodiment, the crown plate 204 is generally diamond-shaped or lozenge-shaped and comprises a top face 500, an opposed bottom face 502 and a pair of side faces 600, 602 extending between the top and bottom faces 500, 502. The crown plate 204 also comprises a V-shaped back face 504, extending between the bottom and top faces 500, 502 and a front end 506. The back face 504 connects the side faces 600, 602 to one another and terminates in a tip 508 at the very back of the crown plate 204.

In one embodiment, the front end 506 is generally T-shaped and is adapted for mounting a bicycle locking assembly 210 (shown in FIG. 2) to the crown plate 204. Such a locking assembly 210 is described in co-pending US patent application entitled METHOD AND APPARATUS FOR SECURING A MOVABLE ITEM TO A STRUCTURE, that was filed on Apr. 23, 2008 and which is incorporated herein by reference. The locking assembly 210 is adapted to cooperate with an element (not shown) mounted to a structure (not shown) in order to secure the bicycle 100 to the structure.

In the embodiment illustrated in FIGS. 5 to 7, the crown plate 204 comprises a pair of concave faces 604, 606 extending toward each other from the side faces 600, 602, respectively. More specifically, the concave face 604 comprises a first, external edge 608 adjacent to the side face 600, an opposed internal edge 610 and an inwardly curving recess 518 defined therebetween. Similarly, the concave face 606 comprises an external edge 614 adjacent to the side face 602, an opposed internal edge 616 and an inwardly curving recess 618 defined therebetween. Extending between the internal edges 610 and 616 of the concave faces 604, 606 respectively is frontwardly extending a protrusion 700. The protrusion 700 comprises a front face 702 extending between the bottom and top faces 500, 502 and having a pair of side edges 704, 706. The protrusion 700 further comprises a pair of spaced-apart side faces 708, 710, extending between the front face 702 and the concave faces 604, 606, respectively. More specifically, the side face 708 extends between the internal edge 610 of the concave face 604 and the side edge 704 of the front face 702, perpendicular thereto. Similarly, the side face 710 extends between the internal edge 616 of the concave face 606 and the side edge 706 of the front face 702, perpendicularly thereto.

As best shown in FIG. 5, in one embodiment, the protrusion 700 of the crown plate 204 is further provided with a circular hole 510 extending between the side faces 708 and 710, perpendicular thereto, for mounting the bicycle locking assembly 210.

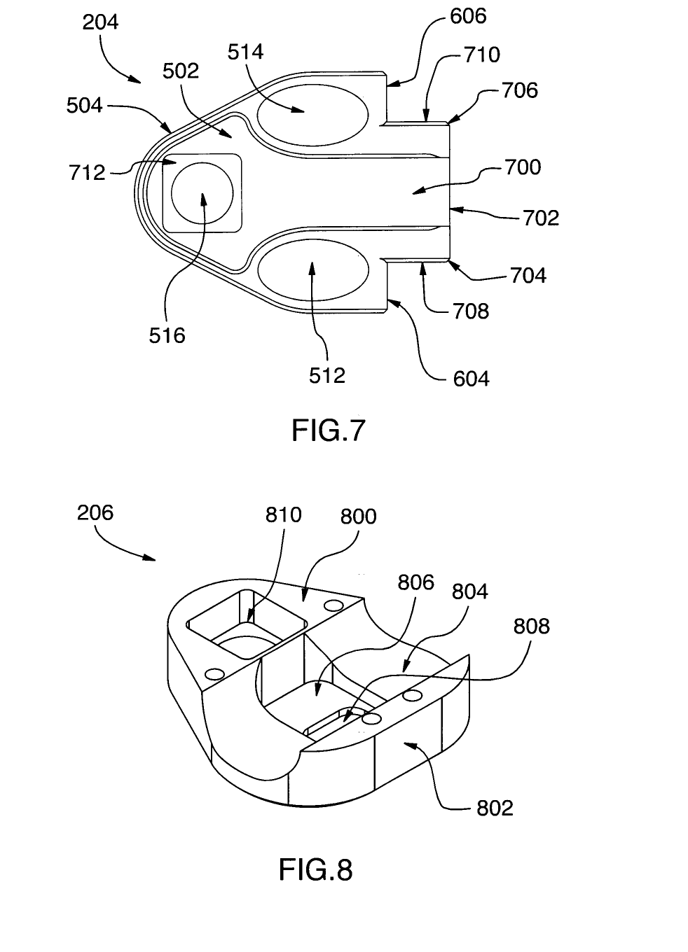

Still referring to FIGS. 5 to 7, proximal to each side face 600, 602 of the crown plate 204 is an oval hole 512, 514, respectively, extending between the top face 500 and the bottom face 502. Each of the oval holes 512, 514 is adapted for receiving therein a respective blade 200, 202, as best described below. In one embodiment, the crown plate 204 also comprises a circular steer hole 516 extending between the top and bottom faces 500, 502, proximal to the tip 508 of the V-shaped back face 504, for mounting the steer assembly 208 thereto. As best shown in FIG. 7, in one embodiment, the steer hole 516 is provided with a generally square recess 712 defined on the bottom face 502 of the crown plate 204, as best described below.

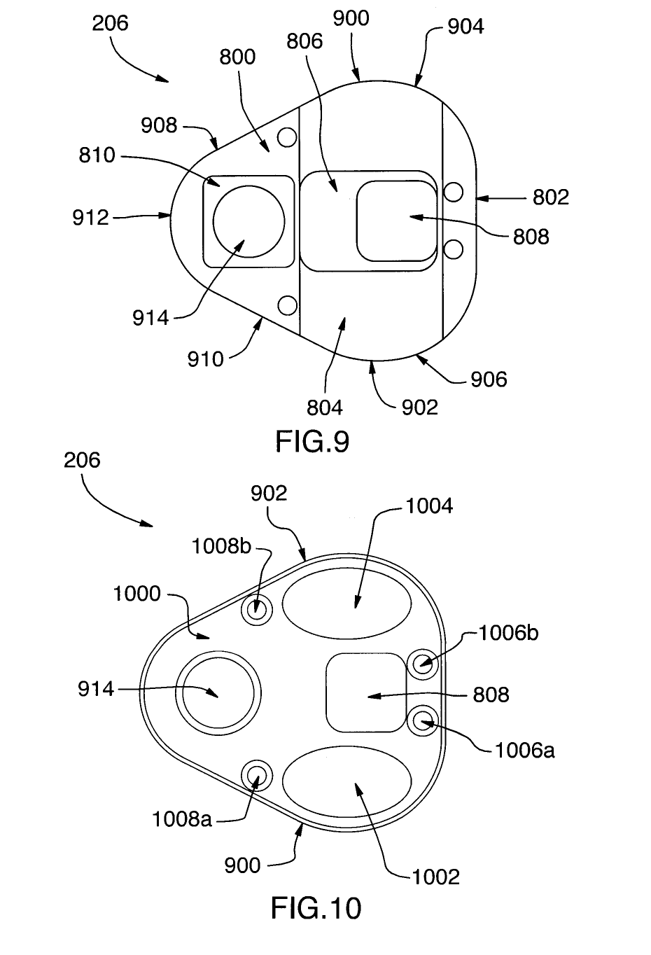

Now turning to FIGS. 8 to 10, the stem plate 206 will be described. In the illustrated embodiment, the stem plate 206 is generally diamond-shaped and comprises a top face 800, an opposed bottom face 1000 and a front face 802. The stem plate 206 further comprises a pair of side faces 900 and 902, each side face 900, 902 comprising a curved front end 904, 906, respectively, connected to the front face 802 and a back end 908, 910. The back ends 908 and 910 of the side faces 900 and 902 converge toward one another to terminate into a curved tip 912.

As best shown in FIG. 8, in one embodiment, the stem plate 206 is further provided with a handlebar recess 804 for mounting the handlebar 112 to the stem plate 206, as it will become apparent below. The handlebar recess 804 is defined on the top face 800 of the stem plate 206 and extends between the side faces 900 and 902, proximal to the front face 802 and parallel thereto. The recess 804 has a semi-oblong cross-section (best shown in FIG. 19) which is adapted to receive the handlebar 112 therein. Defined at the bottom of the recess 804 are a generally rectangular recess 806 and a square hole 808 extending from the rectangular recess 806 to the bottom face 1000 for allowing the passage of the front brake, rear brake and gear shifter cables 1902, 1904 and 1906 shown in FIG. 19 therethrough, as best described thereinafter.

In the illustrated embodiment, the stem plate 206 further comprises a circular steer hole 914 extending between the bottom and top faces 800, 1000 for mounting the steer assembly 208 thereto, and a square recess 810 defined on the top face 800 and vertically aligned with the steer hole 914.

In the illustrated embodiment, the steer assembly 208 is operatively mounted to each of the crown plate 204 and the stem plate 206. The skilled addressee will however appreciate that the steer assembly 208 may be mounted to a single one of the crown plate 204 and the stem plate 206, as long as it enables to operatively connect the fork assembly 108 to the frame 102 of the bicycle 100.

Referring again to FIG. 10, in one embodiment, defined on the bottom face 1000, proximal to the front ends 904 and 906 of the side faces 900 and 902, respectively, are oval recesses 1002, 1004. The oval recesses 1002, 1004 are adapted for respectively receiving therein the top ends 302 of the blades 200 and 202. In a further embodiment, fastening holes 1006a, 1006b, 1008a and 1008b extend from the top face 800 to the bottom face 1000 for fastening a stem cover 1100, as it will become apparent below.

The skilled addressee will appreciate that the crown plate 204 and the stem plate 206 may be differently shaped as long as they are adapted for holding the blades 200, 202 in the appropriate position, as it will become more apparent upon the reading of the present description. For example, projecting members (not shown) defining a receiving area for the blades 200, 202 may be used in place of the oval recesses 1002, 1004 of the stem plate 206.

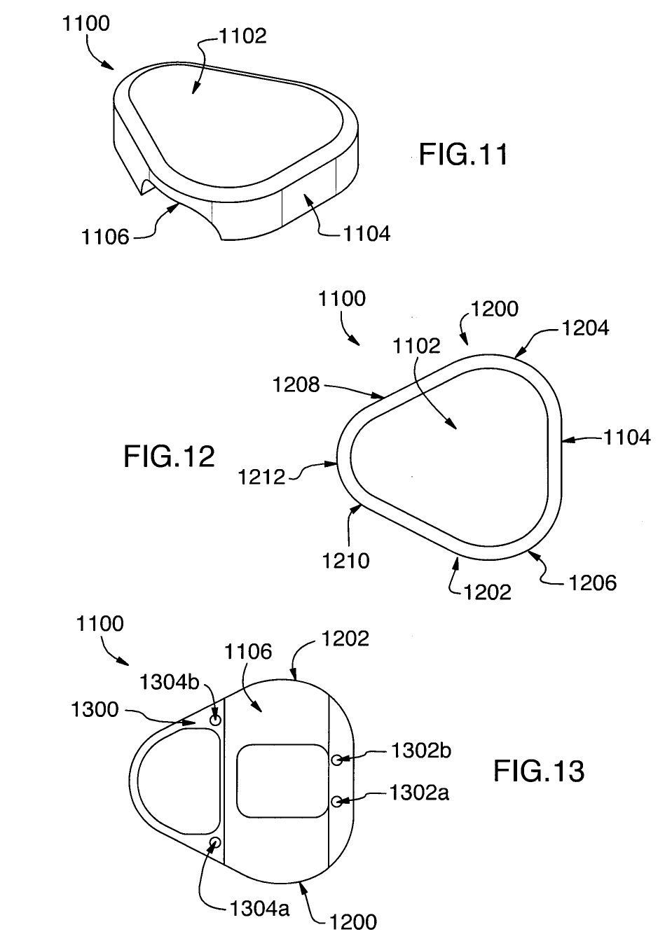

Referring now to FIGS. 11 to 13, in one embodiment, the fork assembly 108 may be further provided with a stem cover 1100 for mounting with the stem plate 206. In one embodiment, the stem cover 1100 comprises a diamond-shaped top face 1102 and a diamond-shaped bottom face 1300, the top and bottom faces 1102 and 1300 being sized similarly to the top and bottom faces 800 and 1000 of the stem plate 206. The stem cover 1100 further comprises a front face 1104 and a pair of side faces 1200 and 1202, each side face 1200, 1202 comprising a curved front end 1204, 1206, respectively, connected to the front face 1104 and a back end 1208, 1210. The back ends 1208, 1210 of the side faces 1200 and 1202 converge toward one another to terminate into a curved tip 1212.

As best shown in FIG. 11, in one embodiment, the stem cover 1100 is further provided with a handlebar recess 1106 defined on the bottom face 1300 and extending between the side faces 1200, 1202 thereof for partially receiving therein the handlebar 112, as best described below. As such, in one embodiment, the recess 1106 has a semi-oblong cross-section, as best shown in FIG. 19.

Defined on the bottom face 1300 of the stem cover 1100 are two pairs of threaded holes 1302a, 1302b and 1304a, 1304b. The treaded holes 1302a, 1302b and 1304a, 1304b can be aligned with the fastening holes 1006a, 1006b and 1008a, 1008b of the stem plate 206 for receiving therein threaded fasteners (not shown) for securing the stem cover 1100 to the stem plate 206, as it will become apparent below.

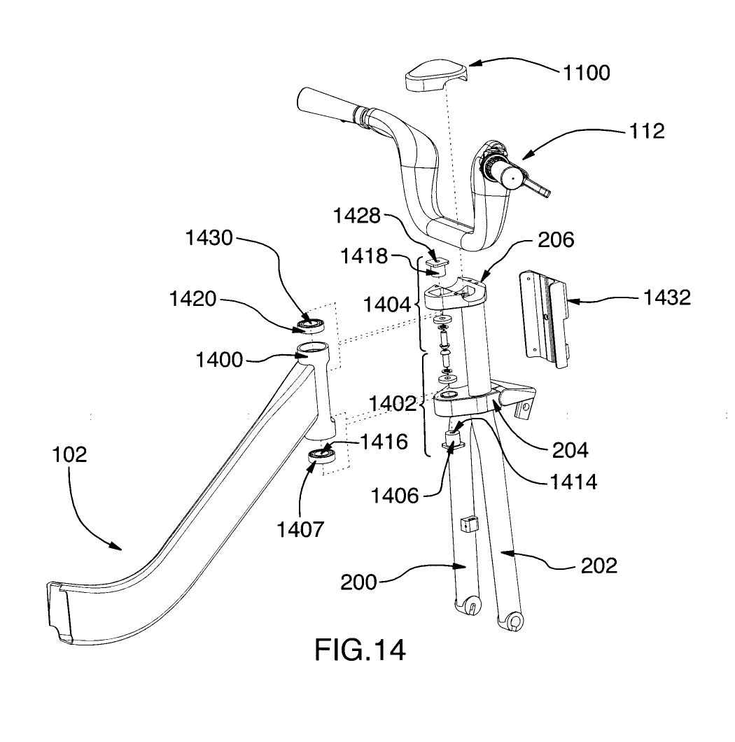

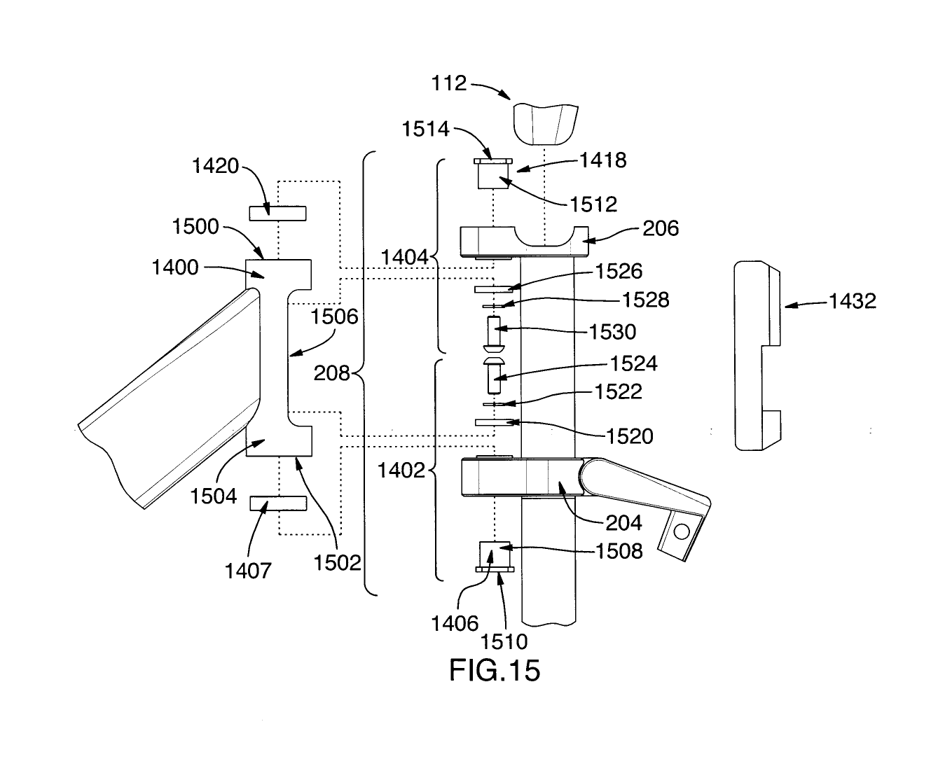

Referring now to FIGS. 14 and 15, the mounting of the fork assembly 108 will now be described in accordance with one embodiment. The blades 200 and 202 are positioned in a side-by-side relation. The steer portion 308 of the blades 200 and 202 is slid in the oval holes 512 and 514 of the crown plate 204, respectively, until the intermediate location 306. The blades 200 and 202 are then secured to the crown plate 204 by welding (not shown). The skilled addressee will appreciate that the blades 200 and 202 could be secured differently such as, for instance, by press fit, gluing or by using fasteners such as nuts and bolts. The oval recesses 1002 and 1004 of the stem plate 206 are aligned with the oval holes 512 and 514 of the crown plate 204 and the top end 302 of the blades 200 and 202 are forced therein. The stem plate 206 is then welded or otherwise fastened to the blades 200 and 202.

In the illustrated embodiment, the steer portions 308 of the blades 200 and 202 being generally straight and the oval holes 512 and 514 of the crown plate 204 being aligned with the corresponding recesses 1002 and 1004 of the stem plate 206, the steer portions 308 of the blades 200, 202 are parallel to one another once the fork assembly 108 is assembled, while the wheel portions 304 thereof extend downwardly from the bottom face 502 of the crown plate 204, gently away from one another. Further, the bottom face 1000 of the stem plate 206 and the top face 500 of the crown plate 204 are parallel to one another, thereby defining a space 402 therebetween, as best shown in FIG. 4. The space 402 is adapted for receiving a head tube 1400 mounted to one end of the bicycle frame 102, as detailed below.

In accordance with one embodiment, as better shown in FIG. 19, the frame 102 of the bicycle 100 comprises a hollow passageway 1910 therein devised to receive at least a portion of at least one control cable, as detailed below. As best shown in FIGS. 14 and 15, the head tube 1400 is generally cylindrical and comprises a top, open end 1500, an opposed, bottom end 1502 and a curved face 1504 extending therebetween. The head tube 1400 further comprises a back opening 404 (shown in FIG. 4) in communication with the hollow passageway 1910 of the frame 102 and a front opening 1506. As it will become apparent below, the front and back openings 1506 and 404 of the head tube 1400 are adapted for providing a communication channel between the space 402 defined between the steer portions 308 of the blades 200, 202 and the hollow passageway of the frame 102, thereby enabling the passage of a rear brake cable 1904 and a gear shifter cable 1906 therethrough towards the hollow passageway of the frame 102, as best shown in FIG. 19. Furthermore, the front opening 1506 allows mounting the fork assembly 108 to the bicycle frame 102.

More specifically, the fork assembly 108 is mounted to the head tube 1400 of the bicycle 100 with the steer assembly 208. In one embodiment, the steer assembly 208 comprises pivoting means for pivotally connecting the frame 102 of the bicycle 100 to the fork assembly 108. In the illustrated embodiment, the pivoting means of the steer assembly 208 comprises a lower steer set 1402 and an upper steer set 1404. In one embodiment, the lower steer set 1402 comprises a knob 1406, a ball bearing 1407, a washer 1520, a stop washer 1522 and a bolt 1524.

In one embodiment, the knob 1406 of the lower steer set 1402 comprises a cylindrical portion 1508 receivable in the cylindrical hole 516 of the crown plate 204 and a square head 1510. The square head 1.510 is adapted to be received in the square recess 712 of the crown plate 204 once the knob 1406 is properly positioned. A threaded hole 1414 is provided in the cylindrical portion 1508 for receiving therein the bolt 1524 of the lower steer set 1402.

In one embodiment, the ball bearing 1407 has an annular configuration and comprises an outer diameter adapted for placing the ball bearing in the head tube 1400, at the lower end 1502 thereof, and also comprises a circular hole 1416. The circular hole 1416 is adapted for receiving therein a section of the cylindrical portion 1508 of the knob 1406 once the fork assembly 108 is secured to the head tube 1400.

Similarly to the lower steer set 1402, in one embodiment, the upper steer set 1404 comprises a knob 1418, a ball bearing 1420, a washer 1526, a stop washer 1528 and a bolt 1530. The knob 1418 of the upper steer set 1404 comprises a cylindrical portion 1512 receivable in the circular hole 914 of the stem plate 206 and a square head 1514. The square head 1514 is adapted to be received in the square recess 810 of the stem plate 206 once the knob 1418 is properly positioned. A threaded hole 1428 extends through the cylindrical portion 1512 for receiving therein the bolt 1530 of the upper steer set 1404.

In one embodiment, the ball bearing 1420 has an annular configuration and comprises an outer diameter adapted for placing the ball bearing 1420 in the head tube 1400, at the upper end 1500 thereof, and also comprises a circular hole 1430. The circular hole 1430 is adapted for receiving therein a section of the cylindrical portion 1512 of the knob 1418 once the fork assembly 108 is secured to the head tube 1400.

In order to mount the fork assembly 108 and the head tube 1400 together, the ball bearings 1406 and 1420 are positioned in the head tube 1400 at the bottom and top ends 1500, 1502 thereof. The fork assembly 108 is then positioned over the head tube 1400, the bottom and top ends 1502, 1500 thereof being adjacent to the top face 500 of the crown plate 204 and to the bottom face 1000 of the stem plate 206, respectively. The circular holes 516 and 914 of the crown and stem plates 204 and 206, respectively, are aligned with the holes 1416 and 1430 of the bearings 1406, 1420 mounted in the head tube 1400.

The knob 1418 of the upper steer set 1404 is slid in the circular hole 914 of the stem plate 206, until the square head 1514 thereof engages the square recess 810. In this position, the cylindrical portion 1512 of the knob 1418 extends through the hole 914 of the stem plate 206 and the circular hole 1430 of the bearing 1420. The washer 1422 and the stop washer 1424 are then placed in the head tube 1400, through the front opening 1506 and aligned with the threaded hole 1428 of the knob 1418. The bolt 1530 is also placed in the head tube 1400, through the front opening 1506, and is fastened into the threaded hole 1428 of the knob 1418.

Similarly, the knob 1406 of the lower steer set 1402 is slid in the circular hole 516 of the crown plate 204, until the square head 1510 thereof engages the square recess 712. In this position, the cylindrical portion 1508 of the knob 1406 extends through the hole 516 of the crown plate 204 and the circular hole 1416 of the bearing 1407. The washer 1408 and the stop washer 1410 are then placed in the head tube 1400, through the front opening 1506 and aligned with the threaded hole 1414 of the knob 1406. The bolt 1524 is also placed in the head tube 1400, through the front opening 1506, and is fastened into the threaded hole 1414 of the knob 1406.

A person skilled in the art will thus appreciate that the front opening 1506 of the head tube 1400 is sized and shaped to enable the introduction of the steer assembly 208 parts in the head tube 1400 for fastening the fork assembly 108 to the frame 102 of the bicycle 100.

The steer assembly 208 is adapted for enabling the fork assembly 108 to pivot relatively to the frame 102 about a generally vertical rotation axis R-R (shown in FIG. 2). As such, the cylindrical holes 516 and 914 of the crown and stem plates 204, 206, as well as the upper and lower steer sets 1404, 1402 are aligned to one another so as to permit pivoting of the fork assembly 108 relative to the frame 102.

In the previously described illustrated embodiment, the steer assembly 208 is connected to each of the crown plate 204 and the stem plate 206 with the corresponding upper steer set 1404 and lower steer set 1402. The skilled addressee will however appreciate that the steer assembly 208 may be connected to a single one of the crown plate 204 and the stem plate 206 with a single corresponding steer set, as long as it enables a pivoting of the fork assembly 108 relative to the frame 102. Moreover, other arrangements for the steer set may be considered, as well known to a person skilled in the art of the invention.

As it will be appreciated by a person skilled in the art, and as previously mentioned, the configuration of the fork assembly 108 provides a space 402 between the steer portions 308 of the blades 200, 202, the crown plate 204 and the stem plate 206. This space 402 is adapted for allowing the passage of the rear brake cable 1904 and of the gear shifter cable 1906 (shown in FIG. 19) from the hole 808 of the stem plate 206 to the front and back openings 1506 and 404 of the head tube 1400, thereby allowing running the control cable through the hollow passageway 1910 of the frame 102 of the bicycle 100. Such a configuration of the fork assembly 108, together with the configuration of the head tube 1400 (i.e. the presence of the front and back openings 1506 and 404) contributes to minimize scrubbing of the control cables against the frame 102 of the bicycle when the fork assembly 108 is pivoted about the axis R-R for controlling the direction of the bicycle, thereby reducing wear and damages to control cables.

Referring now to FIGS. 14 to 17, for closing the space 402 and avoiding the control cables to be exposed, in one embodiment, the fork assembly 108 also comprises a space cover 1432. According to one embodiment, the space cover 1432 has a U-shaped cross-section and comprises a front face 1600 having a top end 1602, a bottom end 1604 and a pair of side ends 1606, 1608. Extending backwardly from each side end 1606, 1608 of the front face 1600, between the top and bottom ends 1602, 1604 are spaced-apart side face 1610, 1612. The cover 1432 is sized to be received between the bottom face 1000 of the stem plate 206 and the top face 500 of the crown plate 204. Upon assembly of the cover 1432 to the fork assembly 108, the top end 1602 of the front face 1600 is located adjacent to the bottom face 1000 of the stem plate 206, proximal to the front face 802 thereof, while the bottom end 1604 of the front face 1600 is located adjacent to the top face 500 of the crown plate 204, proximal to the front faces 604 and 606 thereof. As such, the protrusion 506 of the crown plate 204 extends frontwardly from the cover 1432. Because the side faces 1610, 1612 of the cover 1432 extend backwardly from the front face 1600, each side face 1610, 1612 covers or overlaps the steer portion 308 of one corresponding blades 200, 202.

In one embodiment, the side faces 1610, 1612 of the space cover 1432 are configured to snaply engage the steer portion 308 of the blades 200, 202 for mounting the same to the fork assembly 208. In another embodiment, the side faces 1610, 1612 may be provided with holes (not shown) that can be aligned with corresponding holes (not shown) on the blades 200, 202 for receiving fasteners therethrough, such as, for instance, bolts, screws and rivets.

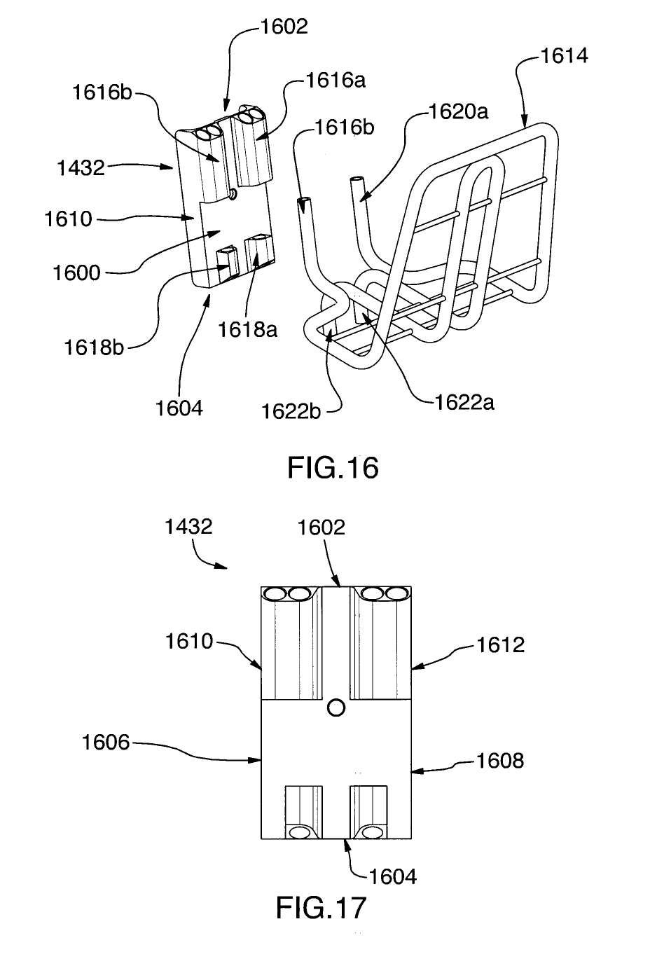

According to one embodiment, and as illustrated in FIG. 16, the space cover 1432 is adapted for mounting a rack 1614 thereto. In this embodiment, the space cover 1432 is provided with a plurality of mounting brackets 1616a, 1616b and 1618a, 1618b extending frontwardly from the front face 1600. The rack 1614 is provided with a corresponding plurality of legs 1620a, 1620b and 1622a, 1622b adapted for engaging the brackets 1616a, 1616b and 1618a, 1618b, respectively.

Referring now to FIGS. 18 and 19, according to one embodiment, the handlebar 112 comprises a hollow, curvilinear upright handlebar mounted to the stem plate 206 for a user to control the bicycle 100 and fitted to accommodate control cables in its structure. In this embodiment, the upright handlebar 112 comprises a generally V-shaped hollow body 1800 provided with a central, stem portion 1801 comprising an opening 1900. Mounted to the V-shaped hollow body 1800 are left and right handle grips 1802, 1804 and left and right break lever assemblies 1806, 1808 for a user to grip the handlebar 112 and control the speed of the bicycle 100. The handlebar 112 is further provided with a gear shifter 1810 operatively mounted to the hollow body 1800 for allowing the user to select a gear ratio. Such a handlebar is described in co-pending US patent application entitled “HANDLEBAR FOR A BICYCLE”, that was filed on Jun. 6, 2008 and which is incorporated herein by reference. Once the handlebar 112 is properly mounted to the fork assembly 108, the opening 1900 of the central stem portion 1801 is aligned with the square hole 808 of the stem plate 206 for allowing the passage of the front brake cable 1902, the rear brake cable 1904 and the gear shifter cable 1906 from the handlebar 112 to the space 402 between the crown plate 204 and the stem plate 206.

For mounting the handlebar 112 to the fork assembly 108, the stem cover 1100 is removed from the stem plate 206 to provide access to the handlebar recess 804 and positioning the handlebar 112 therein. The central portion 1801 of the V-shaped hollow body 1800 is properly positioned in the handlebar recess 804 of the stem plate 206 and the control cables, i.e. the front brake cable 1902, the rear brake cable 1904 and the gear shifter cable 1906, are passed through the opening 1900 towards the space 402. The stem cover 1100 is then positioned on the stem plate 206, over the central portion 1801. In this position, the central portion 1801 of the V-shaped hollow body 1800 is received in the handlebar recess 1106 of the stem cover 1100, as best shown in FIG. 19. The cross-sections of the recesses 804 and 1106 of stem plate 206 and the stem cover 1100 are preferably sized slightly smaller than the cross-section of the central portion 1801 of the hollow body, the bottom face 1300 of the stem cover 1100 being thus prevented from adjoining the top face 800 of the stem plate 206. The threaded fasteners (not shown) are then inserted in the fastening holes 1006a, 1006b and 1008a, 1008b of the stem plate 206, aligned with the treaded holes 1302a, 1302b and 1304a, 1304b of the stem cover 1100 and are screwed with sufficient torque to cause the stem cover 1100 to move downwardly, toward the top face 800 of the stem plate 206. As the stem cover 1100 is moved downwardly by the threaded fasteners (not shown), the central portion 1801 of the V-shaped hollow body 1800 becomes squeezed or sandwiched in the handlebar recesses 804 and 1106 of the stem plate 206 and of the stem cover 1100, thereby securing the handlebar 112 to the fork assembly 108.

As it will be appreciated by a person skilled in the art, the configuration of the fork assembly 108, together with the handlebar 112 and the head tube 1400 of the frame 102 enables running the front brake cable 1902, the rear brake cable 1904 and the gear shifter cable 1906 inside the components of the bicycle 100. More specifically, the front brake cable 1902, the rear brake cable 1904 and the gear shifter cable 1906 run from the left brake lever assembly 1806, the right brake lever assembly 1808 and the gear shifter 1810 through the V-shaped hollow body 1800, to pass through the opening 1900 of the central stem portion 1801 and the square hole 808 of the stem plate 206. The front brake cable 1902 then enters the blade 200 by the first hole 310, runs downwardly toward the dropout end 300 and exits the blade 200 through the second hole 312 and connect the front brake (not shown). The rear brake cable 1904 and the gear shifter cable 1906 are directed toward the back of the bicycle 100 and pass through the front opening 1506 and the back opening 404 of the head tube 1400 to run inside the frame 102, toward the rear brake (not shown) and the derailleur (not shown), respectively.

According to a further embodiment, the bicycle 100 may be provided with electronic or electric systems and other accessories such as, for instance, an electronic speedometer as well as front and back headlights. Therefore, the bicycle 100 may comprise a battery or other electric sources (not shown) mounted to the bicycle 100 and electric cables (not shown) running from the electric source to the various accessories requiring electric power. A person skilled in the art will appreciate that, similarly to the front brake cable 1902, the rear brake cable 1904 and the gear shifter cable 1906, such electronic or electric cables may be routed inside the frame 102, the fork assembly 108 and the V-shaped hollow body 1800 of the handlebar 112, as the case may be.

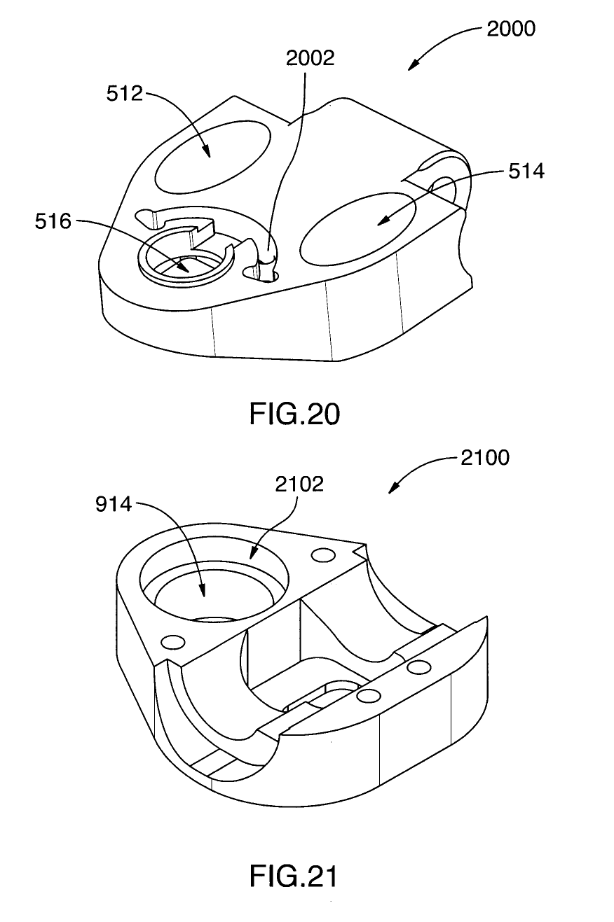

Referring to FIGS. 20 to 25, another embodiment of the fork assembly will now be described.

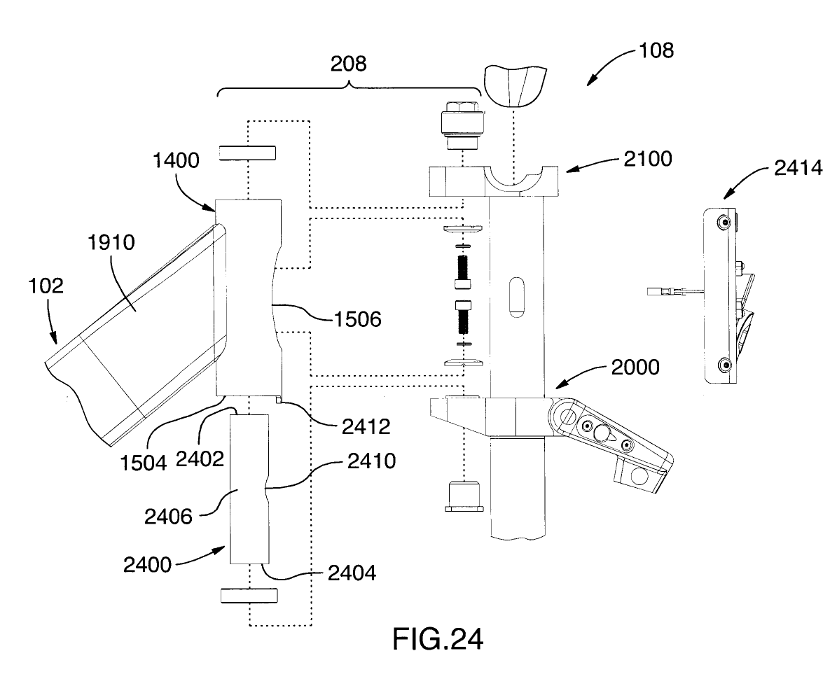

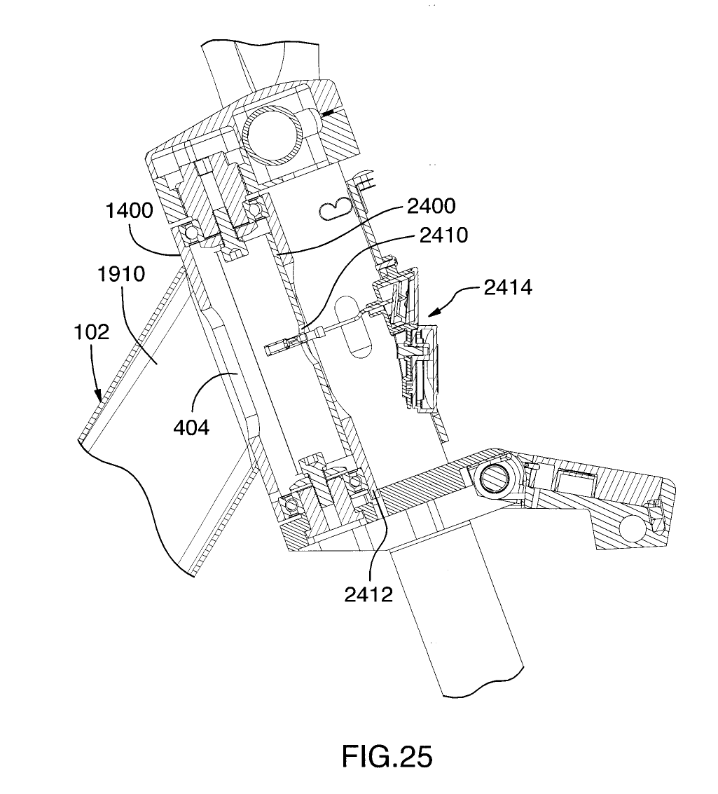

FIG. 20 shows a crown plate 2000 according to another embodiment while FIG. 21 shows a stem plate 2100 according to another embodiment. FIGS. 24 and 25 partially show another embodiment of a fork assembly which embeds the crown plate 2000 and the stem plate 2100. In this embodiment, the steer assembly 208 comprises an elongated inner tube 2400 adapted to be mounted inside the head tube 1400. In this embodiment, the elongated inner tube 2400 is generally cylindrical and comprises a top, open end 2402, an opposed, bottom end 2404 and a curved face 2406 extending therebetween. The elongated inner tube 2400 further comprises a back opening (not shown) facing the back opening 404 of the head tube 1400 and in communication with the hollow passageway 1910 of the frame 102 when the inner tube 2400 is mounted inside the head tube 1400, as detailed below. The inner tube 2400 also comprises a front opening 2410 facing the front opening 1506 of the head tube 1400 when the inner tube 2400 is mounted therein. The skilled addressee will appreciate that the inner tube 2400, thanks to its back opening and its front opening 2410, still enables the passage of a rear brake cable 1904 (not shown) and a gear shifter cable 1906 (not shown) therethrough towards the hollow passageway 1910 of the frame 102. Moreover, the front opening 2410 still allows mounting the fork assembly 108 to the bicycle frame 102, as previously detailed.

In the embodiment illustrated through FIGS. 24 and 25, the head tube 1400 is slightly different from the head tube illustrated in FIGS. 14 and 15 in that it comprises a lower projection 2412 extending downwardly proximate the bottom end 1504.

Referring to FIG. 20, the crown plate 2000 is similar to the crown plate 204 and further comprises a recess 2002 adapted to receive the lower projection 2412 of the head tube 1400. In the illustrated embodiment, the recess 2002 has a semi-circular shape and is located around the steer hole 516, between the steer hole 516 and the two oval holes 512, 514.

Referring now to FIG. 21, similarly to the stem plate 206, the stem plate 2100 also comprises a circular steer hole 914 for mounting the steer assembly 208 thereto. In place of the square recess 810 of the stem plate 206, the stem plate 2100 comprises a circular recess 2102 adapted for receiving a circular head of a knob. The skilled addressee will appreciate that various other arrangements may be considered, as previously mentioned.

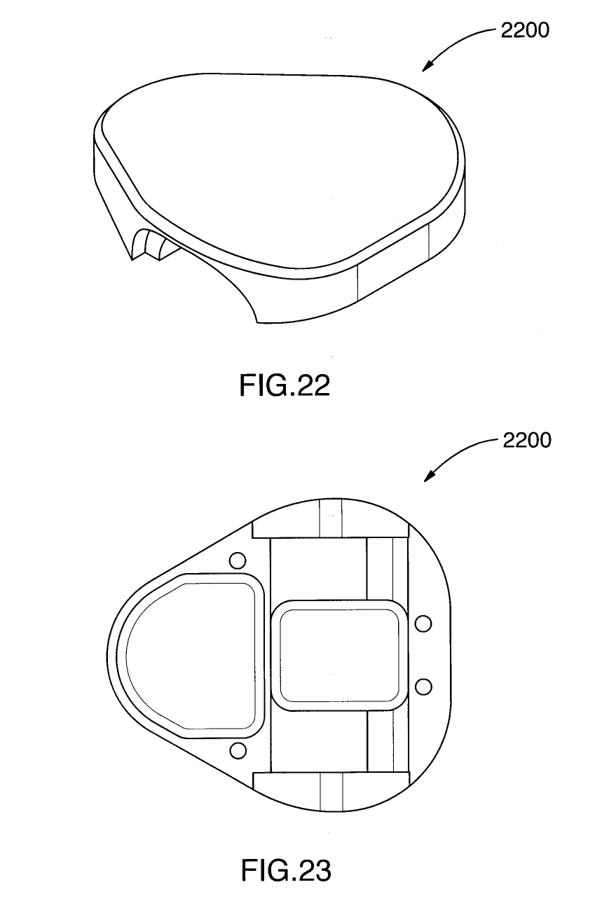

FIGS. 22 and 23 show a stem cover 2200 adapted for mounting with the stem plate 2100 illustrated in FIG. 21.

Referring to FIG. 27, there is shown another embodiment of a space cover. In the illustrated embodiment, the space cover 2700 comprises a hole 2702 extending through the front face 2704 and the back face 2706 of the space cover 2700 for receiving a front light system 2414 (shown in FIGS. 24 and 25) therein.

In the case a front light system is mounted on the front of the bicycle, a direct-current generator (not shown), also called a dynamo, may be mounted with one of the wheels of the bicycle, as well known in the art. It may be advantageous to mount the direct-current generator on the front wheel since the electric cable connecting the direct-current generator to the front light system may be concealed inside one of the blades 200 202, through the cables holes 310, 312, similarly to the front brake cable 1902. The skilled addressee will however appreciate that the dynamo may be mounted on the rear wheel of the bicycle.

The skilled addressee will also appreciate that a rear light system (not shown) may be mounted on the rear of the bicycle. In this case, the electric cable connecting the dynamo to the rear light system may be concealing inside one of the blades 200, 202 and directed towards the back of the bicycle, similarly to the rear brake cable 1904 and as detailed above.

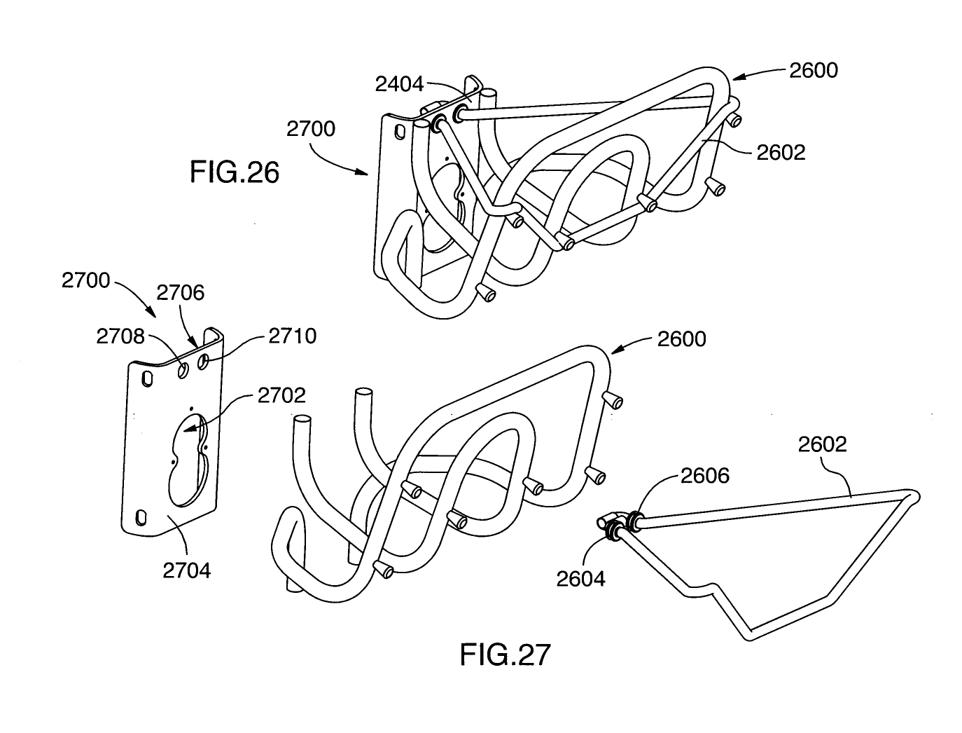

Referring to FIGS. 26 and 27, another embodiment of a rack for mounting on the front of the bicycle is illustrated. In the illustrated case, the rack 2600 is welded on the front face 2704 of the space cover 2700. Moreover, as illustrated, the rack is further provided with a resilient cable 2602 having a first end 2604 and a second end 2606 attached to the space cover 2700 through the holes 2708, 2710. This resilient cable 2602 may be particularly useful since it enables to hold correctly things disposed in the rack 2600. The skilled addressee will however appreciate that many other arrangement may be considered.

According to another aspect, there is also provided a fork assembly kit for a bicycle having a frame. The kit comprises a first blade and a second blade, each of the first blade and the second blade comprising a lower wheel portion and an upper steer portion defining a junction therebetween. The fork assembly kit also comprises a crown plate mountable to the steer portion of the first blade and the steer portion of the second blade. The fork assembly kit also comprises a stem plate mountable to the steer portion of the first blade and to the steer portion of the second blade above the crown plate. The stem plate and the crown plate are adapted for holding the blades in a position for receiving a wheel of the bicycle between the wheel portion of the first blade and the wheel portion of the second blade and for defining a space between the steer portion of the first blade and the steer portion of the second blade when the stem plate is mounted to the steer portion of the first blade and to the steer portion of the second blade. The fork assembly kit also comprises a steer assembly for operatively connecting at least one of the crown plate and the stem plate to the frame of the bicycle.

According to another aspect, a method for routing at least one control cable of a bicycle having a frame is also disclosed. The method comprises providing a fork assembly as previously described; mounting the fork assembly to the frame of the bicycle; providing a handlebar comprising the at least one control cable, the at least one control cable being internally routed inside the handlebar towards a lower opening defined in the handlebar; and mounting the handlebar to the stem plate of the fork assembly such that the control cable of the handlebar runs through the lower opening thereof towards the space defined between the steer portion of the first blade and the steer portion of the second blade and further towards at least one of the frame and the front wheel of the bicycle.

In one embodiment, the method further comprises providing a stem cover adapted for mounting with the stem plate to secure the handlebar between the stem cover and the stem plate; and mounting the cover plate to the stem plate for securing the handlebar therebetween.

In a further embodiment, the method further comprises providing, in at least one of the first blade and the second blade, a hollow passageway, a first upper cable hole located in the steer portion and a second lower cable hole located in the wheel receiving portion for concealing one of the control cables in the hollow passageway of the corresponding blade; and running the corresponding control cable from the space defined between the steer portion of the first blade and the steer portion of the second blade towards the second lower cable hole located in the wheel receiving portion.

Although the foregoing description and accompanying drawings relate to specific preferred embodiments of the present invention as presently contemplated by the inventor, it will be understood that various changes, modifications and adaptations, may be made.

1. A fork assembly for a bicycle having a frame, said fork assembly comprising:
a first blade and a second spaced-apart blade, each of the first blade and the second blade comprising a lower wheel portion and an upper steer portion defining a junction therebetween, at least one of the first blade and the second blade comprising a hollow passageway therealong for concealing a control cable therein;
a crown plate mounted to the steer portion of the first blade and the steer portion of the second blade;
a stem plate mounted to the steer portion of the first blade and to the steer portion of the second blade above the crown plate, the stem plate and the crown plate being adapted for holding the blades in a position for receiving a wheel of the bicycle between the wheel portion of the first blade and the wheel portion of the second blade and for defining a space between the steer portion of the first blade and the steer portion of the second blade; and
a steer assembly for operatively connecting at least one of the crown plate and the stem plate to the frame of the bicycle.

2. The fork assembly as claimed in claim 1, wherein the upper steer portion of the first blade and the upper steer portion of the second blade are straight and parallel to each other, the lower wheel portion of the first blade and the lower wheel portion of the second blade bending outwardly proximal the corresponding junction for providing a wheel space adapted to receive the wheel of the bicycle therebetween.

3. The fork assembly as claimed in claim 1, wherein at least one of the crown plate and the stem plate is secured to the first blade and the second blade using a welding technique.

4. The fork assembly as claimed in claim 1, wherein the steer assembly comprises pivoting means for pivotally connecting at least one of the crown plate and the stem plate to the frame of the bicycle.

5. The fork assembly as claimed in claim 1, wherein each of the first and second blades comprises a lower end, an opposed top end and a dropout mounted at the lower end for mounting the wheel of the bicycle thereto.

6. The fork assembly as claimed in claim 5, wherein the stem plate is mounted at the top end of the first blade and at the top end of the second blade.

7. The fork assembly as claimed in claim 1, wherein the stem plate comprises a top face for mounting a handlebar of the bicycle thereto and an opposed bottom face.

8. The fork assembly as claimed in claim 7, wherein the stem plate comprises a handlebar recess defined on the top face thereof for receiving therein the handlebar.

9. The fork assembly as claimed in claim 8, wherein the stem plate comprises a first recess and a second recess extending on the bottom face thereof, each of the first recess and the second recess being adapted for receiving therein a corresponding top end of one of the corresponding blades.

10. The fork assembly as claimed in claim 8, wherein the stem plate further comprises a hole extending from the top face to the bottom face, the hole being adapted for providing a passageway for at least one control cable therethrough.

11. The fork assembly as claimed in claim 8, further comprising a stem cover adapted for mounting with the stem plate to secure the handlebar received in the handlebar recess of the stem plate between the stem cover and the stem plate.

12. The fork assembly as claimed in claim 10, wherein said at least one control cable is selected from a group consisting of a brake cable and a gear-shifter cable, the at least one control cable extending inside the handlebar and further extending through the hole of the stem plate towards the space defined between the steer portion of the first blade and the steer portion of the second blade when the handlebar is mounted to the stem plate.

13. The fork assembly as claimed in claim 1, wherein the crown plate is mounted at the junctions of the lower wheel portion and the upper steer portion of the first blade and the second blade.

14-19. (canceled)

20. The fork assembly as claimed in claim 1, wherein said at least one of the first blade and the second blade comprising said hollow passageway therealong further comprises a first upper cable hole located in the steer portion and a second lower cable hole located in the wheel receiving portion.

21. The fork assembly as claimed in claim 1, further comprising a space cover mounted against the steer portion of the first blade and the steer portion of the second blade between the stem plate and the crown plate for closing the space between the steer portion of the first blade and the steer portion of the second blade.

22. The fork assembly as claimed in claim 21, wherein the space cover is U-shaped and comprises a first leg and an opposed second leg, each of the first leg and the second leg overlapping a corresponding steer portion.

23. The fork assembly as claimed in claim 21, wherein the space cover comprises at least one mounting bracket for mounting a rack thereto.

24. A bicycle comprising:
a frame;
a fork assembly comprising:
a first blade and a second spaced-apart blade, each of the first blade and the second blade comprising a lower wheel portion and an upper steer portion defining a junction therebetween, at least one of the first blade and the second blade comprising a hollow passageway therealong for concealing a control cable therein;
a crown plate mounted to the steer portion of the first blade and the steer portion of the second blade;
a stem plate mounted to the steer portion of the first blade and to the steer portion of the second blade above the crown plate, the stem plate and the crown plate being adapted for holding the blades in a position for receiving a wheel of the bicycle between the wheel portion of the first blade and the wheel portion of the second blade and for defining a space between the steer portion of the first blade and the steer portion of the second blade; and
a steer assembly for operatively connecting at least one of the crown plate and the stem plate to the frame of the bicycle; and
a handlebar mounted to the stem plate.

25. (canceled)

26. A method for routing at least one control cable of a bicycle having a frame, the method comprising:
providing a fork assembly, said fork assembly comprising:
a first blade and a second spaced-apart blade, each of the first blade and the second blade comprising a lower wheel portion and an upper steer portion defining a junction therebetween, at least one of the first blade and the second blade comprising a hollow passageway therealong for concealing a control cable therein;
a crown plate mounted to the steer portion of the first blade and the steer portion of the second blade;
a stem plate mounted to the steer portion of the first blade and to the steer portion of the second blade above the crown plate, the stem plate and the crown plate being adapted for holding the blades in a position for receiving a front wheel of the bicycle between the wheel portion of the first blade and the wheel portion of the second blade and for defining a space between the steer portion of the first blade and the steer portion of the second blade, the stem plate of the fork assembly comprising a hole extending through a top face and a bottom face thereof; and
a steer assembly for operatively connecting at least one of the crown plate and the stem plate to the frame of the bicycle;
mounting the fork assembly to the frame of the bicycle;
providing a handlebar comprising said at least one control cable, said at least one control cable being internally routed inside the handlebar towards a lower opening defined in the handlebar; and
mounting the handlebar to the stem plate of the fork assembly such that the control cable of the handlebar runs through the lower opening thereof towards the space defined between the steer portion of the first blade and the steer portion of the second blade and further towards at least one of the frame and the front wheel of the bicycle.

27. The method for routing at least one control cable of a bicycle as claimed in claim 26, further comprising:
providing a stem cover adapted for mounting with the stem plate to secure the handlebar between the stem cover and the stem plate; and
mounting the cover plate to the stem plate for securing the handlebar therebetween.

28. (canceled)
